(19) United States
(12) Patent Application Publication
(10) Pub. No.: US 2020/0392259 A1
(43) Pub. Date: Dec. 17, 2020

(54) ORTHOMETALLATED CATALYST COMPONENTS FOR OLEFIN POLYMERIZATION AND COPOLYMERIZATION

(71) Applicant: Gregory G. Arzoumanidis, Naperville, IL (US)

(72) Inventor: Gregory G. Arzoumanidis, Naperville, IL (US)

(21) Appl. No.: 16/900,898

(22) Filed: Jun. 13, 2020

Related U.S. Application Data
(60) Provisional application No. 62/860,920, filed on Jun. 13, 2019.

(51) Int. Cl. C08F 4/643; C08F 10/06; C08F 210/02; C08F 4/659; C09J 123/12; C09J 123/08; C08F 2/06; C08F 2/34

(52) U.S. Cl. CPC C08F 4/6437; C08F 10/06; C08F 210/02; C08F 2/34; C09J 123/12; C09J 123/0815; C08F 2/06; C08F 4/65916

(57) ABSTRACT

Aromatic complexes featuring metal-aryl bonds, active in propylene and other alpha olefin polymerizations are described herein. They are prepared by a single step reaction of readily available ligands Arₓ-L-E with MXy, wherein: Ar=Aryl sigma bonded to L, L=Heteroaromatic or heteroaliphatic ring, with one or more heteroatoms, including fused derivatives, E=Heteroatom on L, available for coordination with the metal. M=Transition metal from groups 3-6, 8, and the lanthanide series of the periodic table of elements. X=Halogenide, y=integer. The ligands react with the TiCl₄ present on MgCl₂ supported polypropylene catalysts and impart substantial activity and other enhancements. They may be used as ethylene or propylene polymerization and copolymerization with higher alpha-olefins, activated with aluminum alkyls such as triethylaluminum.

### CROSS-REFERENCE TO RELATED APPLICATION

This application claims priority from U.S. Provisional Patent Application Ser. No. 62/860,920 filed Jun. 13, 2019, entitled “ORTHOMETALLATED CATALYST COMPONENTS FOR OLEFIN POLYMERIZATION AND COPOLYMERIZATION”, the entire specification of which is hereby incorporated by reference in its entirety.

### BACKGROUND

### Field of the Disclosure

This disclosure relates to orthometallated coordination compounds of transition metals for the stereoregular polymerization or copolymerzation of alpha olefins, either as modifiers of a magnesium-containing supported titanium-containing catalyst, or as independent catalysts components, used in high temperature solution olefin polymerization processes, or supported on silica and used in gas-phase or bulk olefin polymerization processes. The compounds have new composistion of matter, and are useful in synthetic organic chemistry, as precursors for the synthesis of metalodrugs and in polymerization catalysis for producing homopolymers, copolymers and adhesives of alpha-olefins

### Background Art and Summary of the Disclosure

It is desirable to produce propylene polymers, propylene/ethylene copolymers, ethylene/a-olefin compositions and adhesives with desired physical properties in a cost-effective manner. For propylene polymers and copolymers, improvements of catalyst activity (Kg of polymer produced per g of catalyst per hour), coupled with reduction of the extractables (polymer fraction soluble in boiling hexane under certain test conditions), is the subject of continuous investigations. Another very important area of interest is improvements in polymer product properties for targeted applications such as film, packaging, automotive, furniture and the like. These product properties include, melt flow rate (MFR), melt index (I2), molecular weight (MW) and molecular weight distribution (MWD), also known as polydispersity, flexural modulus, Young modulus, impact strength, among others.

It is another object of this disclosure to provide new organotitanium and -zirconium starting materials for synthetic applications, especially in the area of metalodrugs for cancer therapy, and catalytic components for olefin polymerization that are simple to prepare, from the following two components:

a. A heteroaromatic organic compound of the general formula Arₓ-L-E, where Ar=a pendant phenyl, biphenyl, naphthyl, anthracenyl and the like, bonded to L, x=integer between 1 and 15, L=single or fused heteroaromatic or heteroaliphatic moiety, containing one or more heteroatoms, or hydrocarbyl with functional groups, E=a heteroatom, part of L, available for coordination with a transition metal.
Arₓ-L-E is a monodentate ligand, meaning that it has only one heteroatom (E) available for coordination with the metal, although the ligand may contain more than one heteroatoms. Many of the ligands are items of commerce.

b. A transition metal reagent such as as a chloride, bromide or fluoride, readily available in large quantities. The metal is anyone of Groups 3 to 6, 8 and the lanthanide group of the Periodic Table of the Elements. Preferably the metal is a Group 4 metal; more preferably metals are titanium and zirconium.

The reaction between the heteroaromatic ligand and the transition metal reagent proceeds through an orthometallation step, resulting in the formation of very active catalytic moieties, featuring a metallocyclic ring with a metal-aryl bond and a metal-heteroatom bond. The orthometallated complexes of the prior art, U.S. Pat. Nos. 7,462,324 or 8,592,615 used as catalysts in olefin polymerization are polydentate, i.e., they have two or more heteroatoms bonded to the metal.

In the area of alpha-olefin polymerization widely used catalysts such as metallocenes and coordination compounds well known to those in the art, are difficult to prepare, involving multiple steps, resulting in low yields, from rare and expensive starting materials. The catalysts of the present disclosure are synthesized under anaerobic conditions in one pot/single step, and they may be easily crystallized and isolated in powder form. They may be used in conjunction with Mg containing supported Ti containing catalysts for stereoregular polymerization of propylene, by the addition of the ligand in situ during catalyst preparation. Such catalysts show substantially improved activity and stereospecificity. In fact, a reduction of external modifiers (e.g., dialkyl dimethoxy sillanes) in the polymerization process by as much as 70% or more may be achieved by the use of the inventive catalysts.

The isolated catalyst components of the present disclosure may be supported on silica, silica/alumina, perfuorinated silica and the like, for use in copolymerizations of ethylene and higher alpha-olefins, such as 1-butene, 1-hexene, 1-octene etc. Furthermore, the isolated catalyst components may be applied in high temperature solution polymerizations and copolymerizations with various alpha-olefins for preparation of adhesives and similar products.

The catalytic complexes of this disclosure react with aluminum alkyls or alkyl chlorides. For example, they react with trialkyl aluminums such as triethyl aluminum (TEA), tri-isobutyl aluminum (TIBA) and the like, to reduce the oxidation state of the transition metal, and to form a titanium-aluminum bimetallic complex featuring chlorine bridges.

One outstanding feature of the orthometalated complexes in alpha-olefin polymerization is their activation with aluminum alkyls such as TEA, unlike the metallocenes and other coordination complexes of the prior art, which require for their activation the presence of the non-coordinating and more expensive anions methylaluminoxanes (MAO), perfluoroborates and the like. Accordingly, we have a desirable simplification of the polymerization process, along with a sizable cost cutting.

The catalytic complexes of the present disclosure display in their structure a metal-aryl carbon bond, formed by an orthometalation reaction during their preparation. The metal-aryl carbon bond is susceptible to an alpha-olefin insertion, see L. N. Lewis et al., J. Am. Chem. Soc., 1986, 108, 2728. Hustad et al in U.S. Pat. No. 8,362,162 report similar alpha-olefin insertions into a Hf-aryl bond of a catalytic complex. Insertion of ethylene gives rise to two stereoisomers and insertion of propylene or higher alpha-olefins creates eight additional stereoisomers, depending on the mode of insertion, 1,2- or 2,1. Each stereoisomer has a different environment around the metal active site, which affect the polymerization and product properties such as MWD. Therefore, these catalytic species which constitute mixtures of stereoisomers have been called “multi-site” catalysts, as compared with metallocenes and other coordination compounds which are “single-site”.

Several small molecules or compounds with functional groups may be inserted into the metal-carbon bond of the catalysts, influencing its catalytic behavior. Small molecules include O₂, CO, CO₂, CS₂, COS, even N₂. Organotitanium compounds containing titanium-aryl carbon bonds react with molecular nitrogen, M. E. Volpin et al, Chem. Commun. 1038 (1968); also, same author “The Reactions of Organometallic Compounds of Transition Metals with Molecular Nitrogen and Carbon Dioxide” p. 612, pac.iupac.org. Compounds with functional groups capable of inserting into the metal-carbon bond include imines, carbonitriles, ketones, aldehydes, isonitrilels, esters, amides, cyanates, isocyanates, thiocyanates, and isothiocyanates.

Most single-site catalysts for stereospecific propylene polymerization and copolymerization are derivatives of Zr, Hf, or Cr. Notable examples are included in U.S. Pat. Nos. 8,168,556, 8,299,287, 7,579,415, 7,504,354, 7,452,949, 7,241,903, 7,342,078, 8,207,281, 7,618,912, 7,799,879, 7,544,749, 8,362,163, US 2003/0204017, U.S. Pat. No. 7,087,690.

The same is true for catalysts used in ethylene polymerization and copolymerization (except for the constrained geometry catalysts), as in U.S. Pat. Nos. 7,026,494, 8,138,113, 8,383,754, US 2009/0281342, US 2008/0004460, US 2009/0281342, U.S. Pat. Nos. 8,329,834, 8,367,853, 7,547,754, 7,064,096.

Single-site Ti-based catalysts are not preferred embodiments because they may underperform their Zr, Hf, or Cr counterparts. To the contrary, Ti derivatives of orthometallated catalytic complexes of the present disclosure are preferred, especially when used as co-modifiers of magnesium chloride supported titanium chloride catalysts, described by Arzoumanidis et al in U.S. Pat. Nos. 4,866,022, 4,540,679, 4,612,299, 4,988,656, 5,013,702, 5,081,090, and by Cohen et al in U.S. Pat. No. 4,946,816. Widely used modifiers or internal electron donors of the aforementioned catalysts are organic compounds containing oxygen, nitrogen, sulfur, phosphorus, and/or silicon.

Specific examples of commonly used modifiers include aromatic carboxylic acid esters such as ethyl benzoate, particularly diesters such as butyl and octyl phthalates, succinates and the like, as well as diethers, as shown in U.S. Pat. Nos. 7,316,987, 7,560,521. Other common internal modifiers include carbonates, US 2011/0130529, U.S. Pat. No. 8,263,520; sulfonyl compounds U.S. Pat. Nos. 8,404,789, 8,470,944; a pair of organosilicon compounds, U.S. Pat. No. 8,426,537, US 2012/004378, EP 2 360 190; ketone-ether derivatives U.S. Pat. Nos. 8,003,558, 8,288,488; aliphatic cyclic esters 2008/0113860, EP 20100180083, U.S. Pat. No. 7,888,438; 1,8-naphthyl-diaryloates U.S. Pat. No. 8,003,558; and in-situ formation of di-octyl-phthalate, using an emulsion process to control particle morphology U.S. Pat. No. 8,216,957.

New internal modifiers which are made part of the present disclosure include diesters of 5-nonbornene-2-2-dimethanol, pinanediol, dihydro-1-3-dioxepin, catechol, 2-hydroxy-benzyl alcohol, benzopinacol, 1,2-dihydroxy indan, and 1,1′-dihydroxybiphenyl, with aliphatic acids such as propionic, butyric, octanoic and the like, or with aromatic acids such as benzoic, toluic and the like. Ortho hydroxy benzoic acid or aliphatc alpha or beta hydroxy acid di-esters may also be used.

Apart from the different modifiers used in the aforementioned catalysts, they may also differ by the starting magnesium compound employed during their preparation, e.g., either dry MgCl₂ adducts with various alcohols, soluble in selected solvents, or magnesium alkoxides, Grignard reagents, etc, and by the preparation procedure (recipe) itself. All these factors will impact catalyst performance, such as catalyst activity (Kg of polymer produced per g of catalyst per hour), the level of the atactic material produced, and various polymer product properties.

Studies have shown (Y. V. Kissin, Polymerization of Olefins with Heterogeneous Ziegler-Natta Catalysts, Springer-Verlag, p. 248) that butyl phthalates are being removed from the solid catalyst particles up to 80% through reaction with AlEt₃, under polymerization conditions. Under the same conditions, 1,3-diethers are not removed. This may explain in part the superior performance of diethers as internal modifiers. We assume all the modifiers mentioned above may be removable at least in part from the solid particles, by the reaction with AlEt3.

Another fact to consider is that the above mentioned internal donors are coordinated exclusively with the MgCl₂ support, Arzoumanidis et al, Catalytic Olefin Polymerization, Proceedings of International Symposium, Tokyo, October 1989, Kodansha Ltd, p. 147. Electron microscopic studies show that most of the ester modifiers are buried inside the catalyst crystallites, and the surface of the catalyst particle is almost void of them.

The orthometalated catalysts of the present disclosure improve the performance (activity, stereospecificity, polymer product properties) of all the aforementioned magnesium supported titanium-containing catalysts. They interact with the magnesium chloride support as the rest of the internal modifies do, but in a preferred way, on the 110 lateral cut of MgCl₂.

Orthometallated hafnium complexes with heteroaryl ligands, primarily derivatives of imidazole and benzimidazole, suitable for alpha-olefin polymerizations, have been described in US 2004/0220050, US 2009/0306318, U.S. Pat. Nos. 8,362,162, 8,362,163. Orthometallation in these complexes gives rise to multi-site behavior during alpha-olefin polymerization. Their preparation is an elaborate multi-step process, which is undesirable for commercial applications. By comparison, the orthometalated complexes of the present disclosure may be prepared in a single step, with starting materials readily available, even in bulk quantities. Complexes of titanium, zirconium, hafnium, chromium, vanadium, samarium, ytrium, tantalium, niobium, iron, nickel, cobalt may be prepared similarly. Moreover, these complexes may be simply activated with aluminum alkyls such as TEA and TIBA, unlike the complexes of the aforementioned patents, which are activated by non-coordinating anions, as thoroughly described therein. There have been reports of some transition metal complexes being activated with TEA and TIBA, U.S. Pat. No. 8,426,539. However, the polymer yield of such systems is minuscule.

The complexes of the present disclosure and/or the products of their reaction with aluminum alkyls, may be supported on silica or treated silica with ammonium hexafluorosilicate, US 2013/0035463, or other fluorine compounds, U.S. Pat. No. 8,426,539. The supported catalysts prepared by these methods are particularly useful in ethylene polymerization and copolymerization. In the latter case they may accept high levels of the higher olefins 1-butene, 1-hexene, 1-octene etc. because they represent more open structures.

Likewise, the complexes represent robust structures that are stable, at temperatures as high as 200° C. or higher. As such, they are very suitable for use in high temperature solution processes described in U.S. Pat. Nos. 8,354,484, and 8,362,162.

Orthometallated complexes, especially those of iridium and other noble metals, find applications in the health industry such as in medicines fighting cancer, and electronics industries, U.S. Pat. No. 7,923,521. The complexes of the present disclosure may also find utility in such applications, as well as in nitrogen fixation as indicated earlier, and in other areas of organic synthesis.

### BRIEF DESCRIPTION OF THE DRAWINGS

FIG. 1 of the drawings is a graphical representation of 13C NMR CPMAS (A) and DDMAS (B) Spectra of 2-Phenyl Indole/TiCl4 Complex;

FIG. 2 of the drawings is a graphical representation of 13C NMR Assignments of 2-Phenyl Indole, the Reaction Product with TiCl4, and the Final Reaction Product with AlEt3;

FIG. 3 of the drawings is a graphical representation of IR Spectrum of 2-Phenyl Indole/TiCl4 Complex;

FIG. 3A of the drawings is a graphical representation of IR Spectrum of 2-Phenyl Indole/TiCl4 Complex;

FIG. 4 of the drawings is a graphical representation of 13C NMR CPMAS Spectra of the Reaction Product of 2-Phenyl Indole/TiCl4 Complex with AlEt₃;

FIG. 5 of the drawings is a graphical representation of 13 NMR CPMAS Spectra of 2-Phenyl Indole/ZrCl4 Complex. The Peak at 181 ppm corresponds to Zr—C Bond;

FIG. 6 of the drawings is a graphical representation of 13C NMR DDMAS Spectra of 2-Phenyl Indole/ZrCl4 Complex;

### DETAILED DESCRIPTION THE DISCLOSURE

The orthometallated complexes of the present disclosure may be prepared in pure toluene as the solvent, or other suitable aromatic or aliphatic hydrocarbons at elevated temperatures, by the reaction of a transition metal chloride or other halogenide, oxychloride, thionylchloride and the like, complexes of said compounds with tetrahydrofuran (THF) or other ethers, and mixtures thereof, with ligands having the general formula:

Arₓ-L-E

where:

Ar=phenyl, biphenyl, naphthyl, phenanthrenyl, anthracenyl, or their isomers. For example, “naphthyl” can be 1-, or 2-naphthyl, “biphenyl” can be 1-, 2-, or 3-biphenyl, “anthracenyl” can be 2-, or 9-anthracenyl, “phenanthrenyl” can be 1-, 2-, 3-, 4-, or 9-anthracenyl.

L=Heteromatic three to seven or higher member ring that contains one or more heteroatoms, the same or different. Specific heteroaromatic rings include, but not limited, to pyridine, pyrimidine, pyrazine, pyrrole furan, imidazole, pyrazole, triazole, thiazole, isothiazole, oxazole, isoxazole, oxadiazole, pospholene, phospholene oxide, phosphorine, and their benzo-fused analogues of these rings such as indole, carbazole, benzofuran, benzothiophene, and the like.

Also, heteroaliphatic, saturated or unsaturated, three to seven or higher member ring that contain one or more heteroatoms, the same or different. Specific heteroaliphatic rings include, but not limited, to ethylene oxide (oxirene), ethylenimine (aziridine), trimethylene oxide (oxetane), tetrahydrofuran, pyrrolidine, piperidine, dioxane, morpholine, trimethylene sulfide, 1,3-diacetidine, 1,2-oxathiolane, oxepane, azocane, thiocane.

Also, hydrocarbyls containing functional groups such as —COR, —NR′R″, —SR, —PR′R″, OR, —N═N—, —CH═N— directly bonded to Ar as defined above. Specific examples include, but not limited to benzophenone, diphenylamine, diphenylether, triphenylphosphine, triphenylphosphine oxide, anisole, and the like.

E=Heteroatom available for coordinarion with the metal, and is part of L. The distinction is made because L may contain more than one heteroatoms, which may not be available for coordination.

Specific examples of transition metal reagents employed in this disclosure include, but not limited, to TiCl₄, ZrCl₄, HfCl₄, VCl₃, VF₃, VOCl₃, V(THF)₃Cl₃, CrCl₃, CrF₃, Cr(THF)₃Cl₃, SmCl₃, YCl₃, TaCl₃, TaCl₅, NbCl₃, NbCl₅, FeCl₂, FeCl₃, NiCl₂, NiBr₂, NiBr₂.CH3OCH2CH2OCH3, NiF₂, CoCl₂, CoBr₂, CoF₂, CoI₂, PdCl₂, PdBr₂, PdI₂, Pd(CF₃CO₂)₂, PtCl₂, PtCl₄, PtBr₂, PtBr₄, RhCl₃, IrCl₃, RuCl₃, OsCl₃.

Preferred reagents are TiCl₄, ZrCl₄, HfCl₄, VCl₃, PdCl₂, most preferred are TiC₄ and ZrCl₄. Specific examples of Arₓ-L-E ligands are the following:

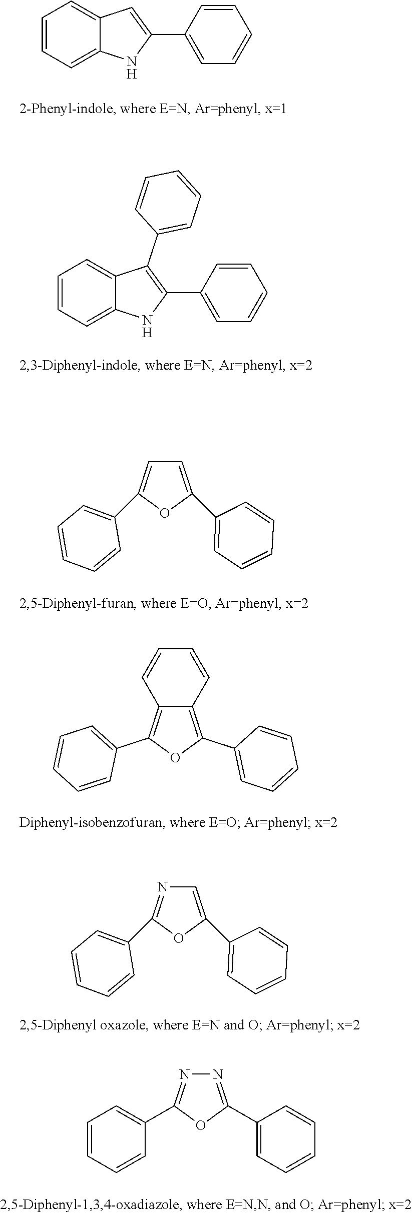

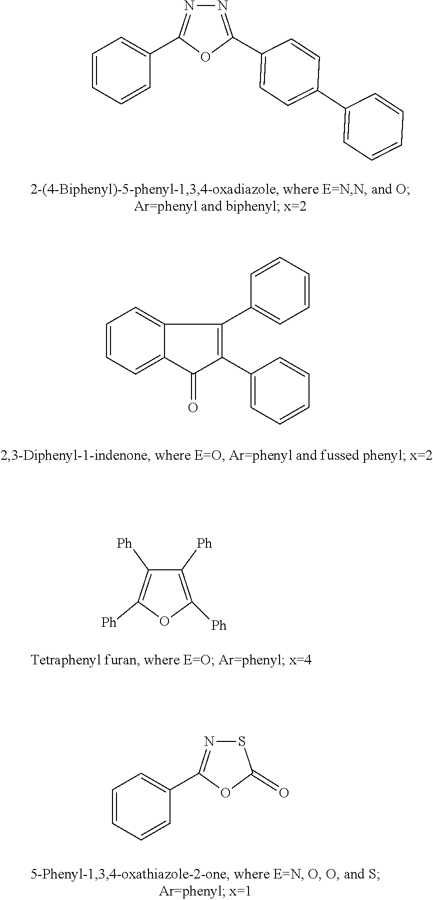 [SMILES: c1ccc(-c2ccc(-c3nnc(-c4ccccc4)o3)cc2)cc1 ; O=C1C(c2ccccc2)=C(c2ccccc2)c2ccccc21 ; c1ccc(-c2oc(-c3ccccc3)c(-c3ccccc3)c2-c2ccccc2)cc1 ; O=c1oc(-c2ccccc2)ns1]

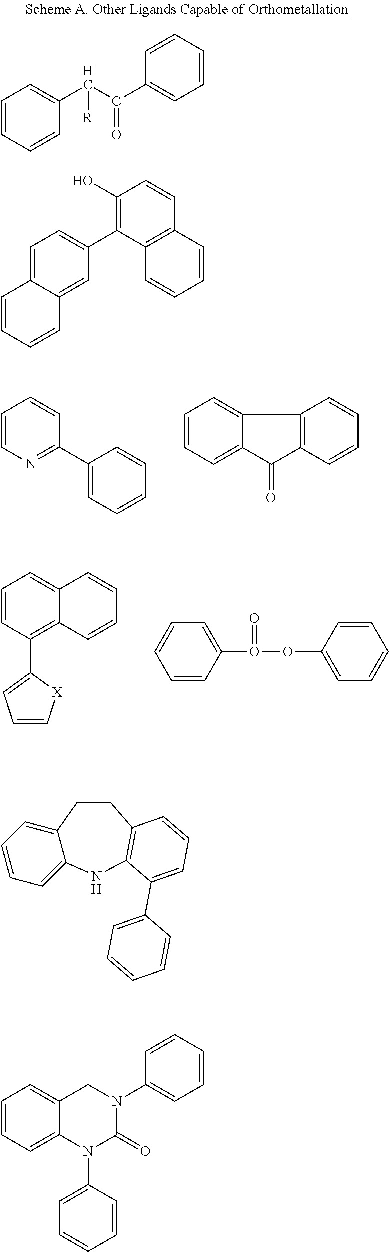

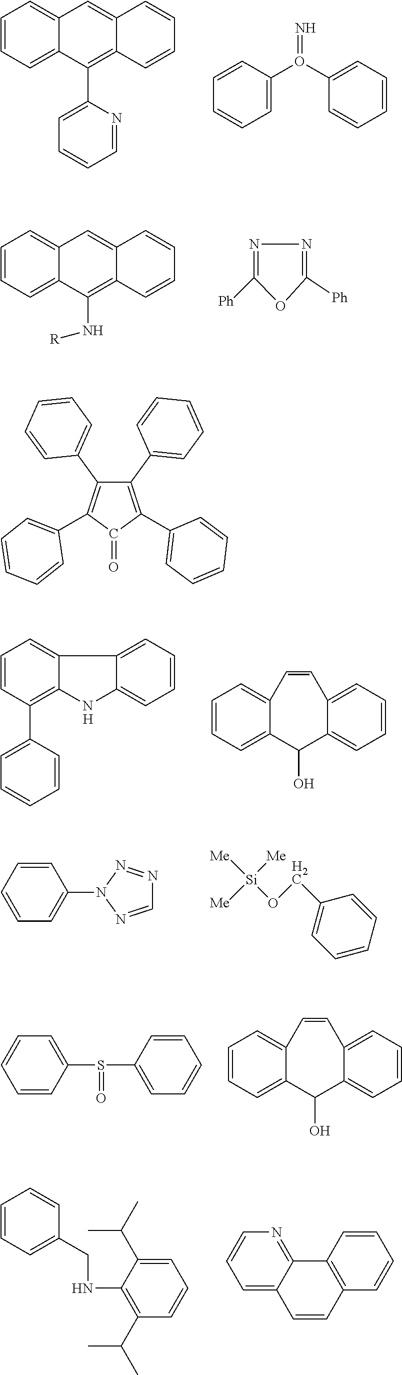

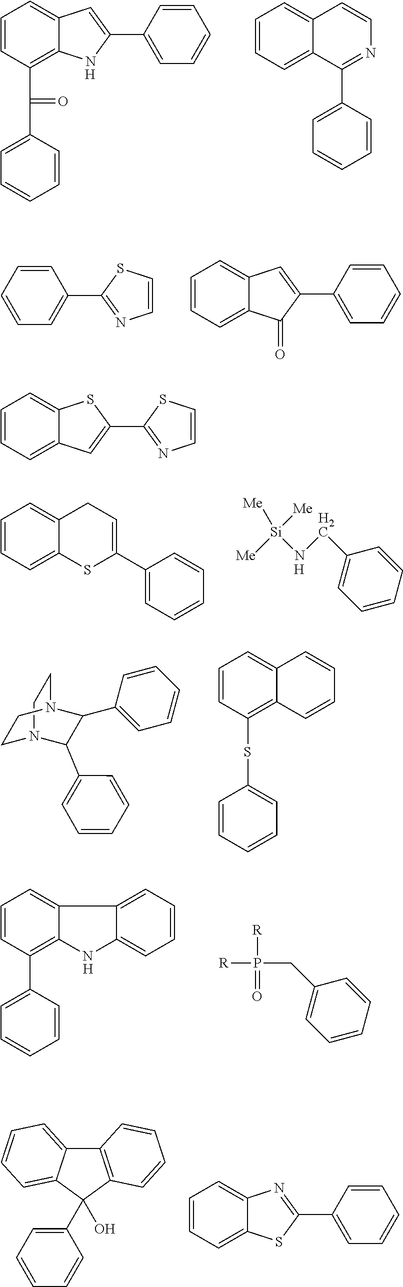

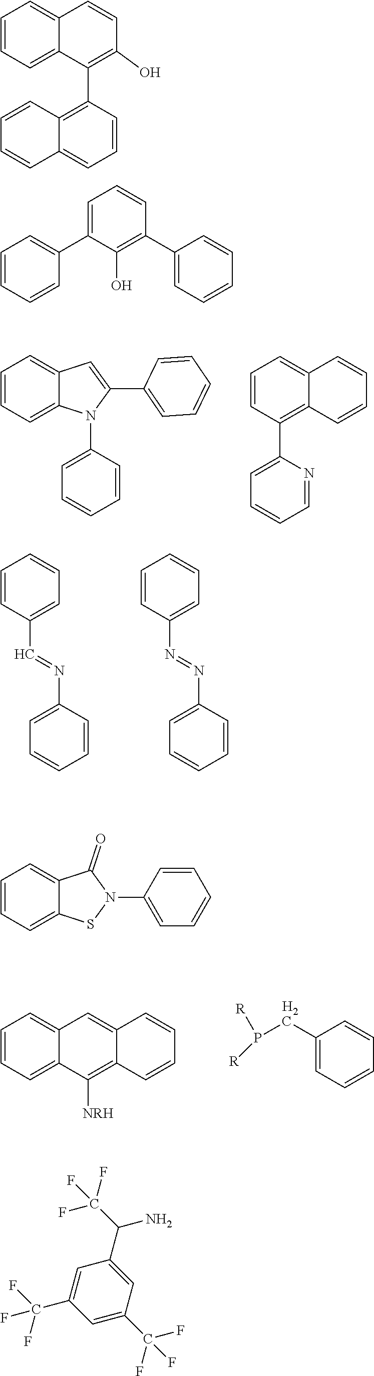

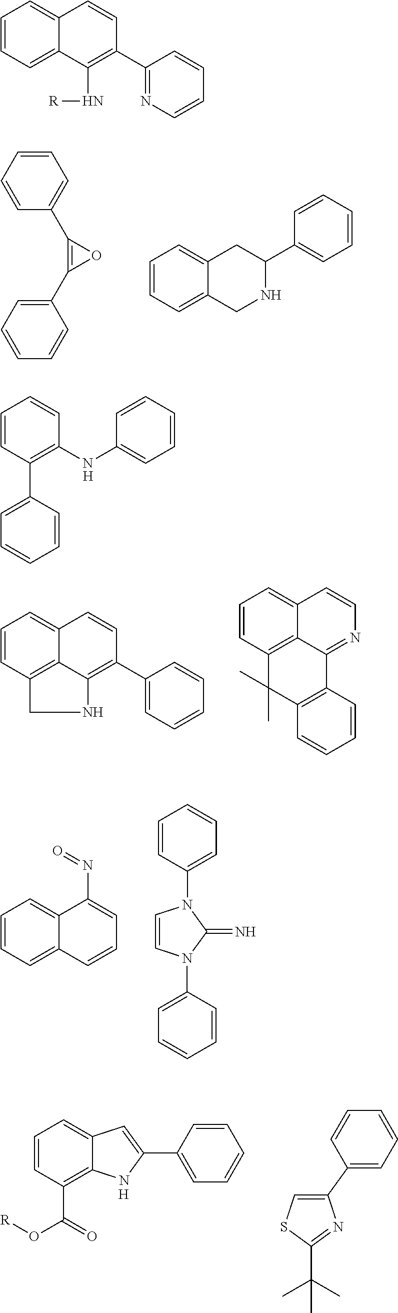

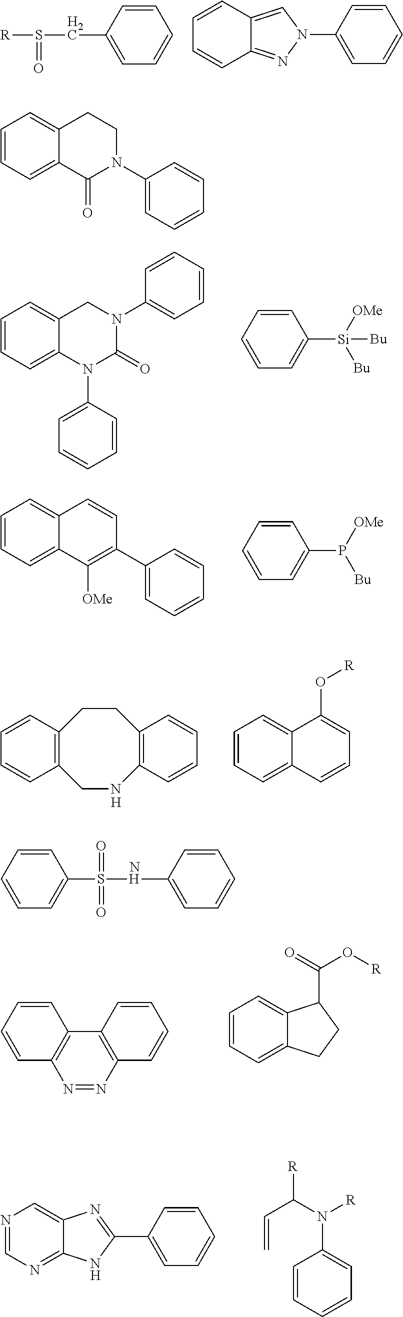

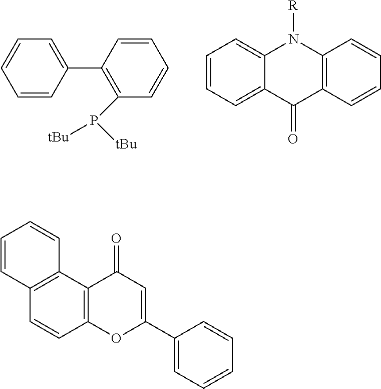

Preferred ligands are 2-phenyl-indole, 2,3-diphenyl-indole, 2,5-diphenyl-oxazole, 2,5-diphenyl-1,3,4-oxadiazole, 2,3-diphenyl-1-indenone and tetraphenylcyclopentadienone. Most preferred are 2-phenyl-indole and 2,5-diphenyl-oxazole.

In a most preferred embodiment, one mole of TiCl₄ reacts with two moles of 2-phenyl-indole in toluene at 100° C. to 105° C. under a dry nitrogen atmosphere, to yield the orthometalated complex IV, according to the following mechanism:

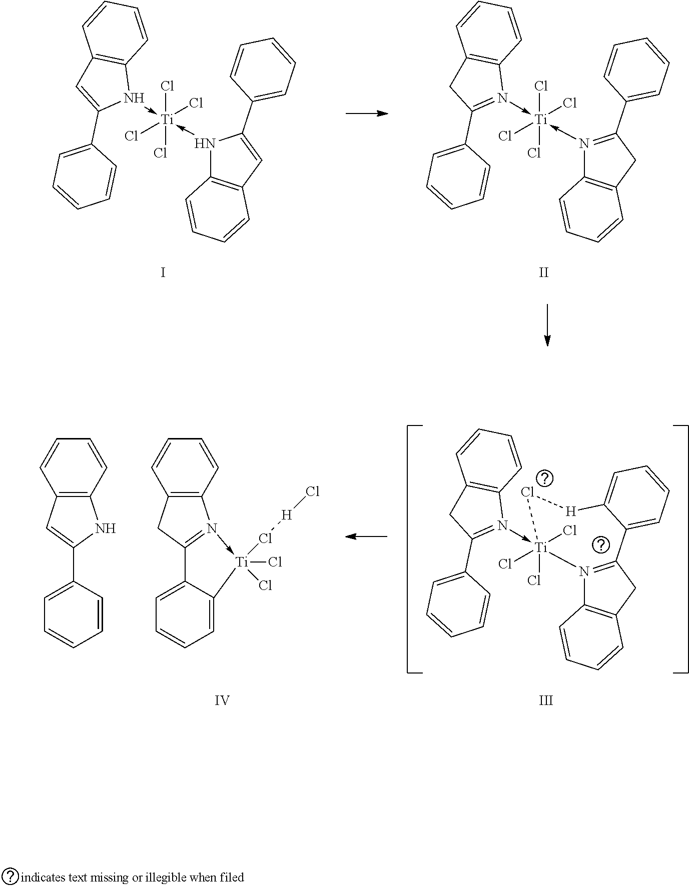

The structure of compound IV, representing a new composition of matter, was elucidated by elemental analysis, solid-state ¹³C NMR spectra, infrared spectra, and computational analysis. The incorporation of HCl in IV, observed for the first time in a Ti complex, has been reported in several other crystal structures, B. H. Ward et al, Chem. Mater., 1998, 10 (4), pp. 1102-1108. Also in “Ph₄As⁺Cl⁻HCl”.

The starting molar ratio of 2:1 of 2-phenyl indole to TiCl₄ is very important, since a different ratio like 1:1 leads to different reaction products. This fact is related to the formation of a 2:1

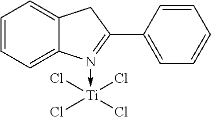

initial complex like I, II, unlike the 1:1 complex V shown below:

During complexation of 2-phenyl indole with TiCl₄, the former isomerizes to the indolenine structure (as in II, with hydrogen migration to the 3 carbon position, and a double bond shift to the 1-2 position), which represents a thermodynamically more stable form for the complex. In the preferred embodiment of 2:1, one mole of 2-phenyl indole is recovered unreacted, along with the final product IV. The trans octahedral bipyramidal configuration of the reaction precursor II is essential for the orthometalation reaction. The bipyramidal confiuration could also be achieved by the presence of one mole 2-phenyl indole, and a mole of another donor compound, such as an amine, a ketone, an ester, etc. Complex IV is also formed in-situ during preparation of magnesium chloride supported Ti chloride catalysts, when mixtures of DNBP and 2-phenyl-indole are introduced as internal modifiers. This part of the disclosure will be discussed in detail.

In another aspect of this disclosure the Ar_{X}-L-E ligands may be polymer-bound, typically on a polystyrene backbone. Several of these materials have a variety of applications including use as supported catalyst components in many chemical reactions, including polymerization. A great number of polymer-bound ligands are commercially available from various sources, particularly from Sigma-Aldrich. As part of the present disclosure, we propose the treatment of polymer-bound Ar_{X}-L-E with one of the transition metal chlorides, preferably TiCl₄ or ZrCl₄, in organic solvents such as toluene, xylenes, chlorobenzene, other chlorinated solvents etc., at elevated temperatures, typically over 100° C., for the formation of an orthometallated, polymer-bound moiety, to serve as catalyst for olefin polymerization.

Examples of commercially available, polymer-bound ligands are: 9-anthracene carboxamide, 1-hydroxybenzotriazole, 4-(dimethylamino) pyridine, triphenylphosphine, 1-hydroxybenzotriazole, diphenylphosphoryl azide, pyridinium p-toluene sulfonate, bipyridine, piperazine, piperazine, morpholine, 6-thionicotinamide, 4-benzyloxybenzaldehyde, benzophenone oxime, trimethylsilyl sulfonate, 4-benzyloxy-2,6-dimethoxybenzaldehyde, carbonyl imidazole, 2,6-di-tert-butyl pyridine, aniline, benzyltriphenyl phosphonium bromide, piperidine, 4-methoxytrityl chloride, diisopropylamine, thiosulphate, 1-formylpiperazine, isatoic anhydride, hydroxylamine, N-benzyl-N′-cyclohexyl carbodiimide, phenol, 2-hydroxyethylmethylphenylsilane, 4-benzyloxybenzylamine, 4-methyl benzydrylamine, 2-chlorobenzydrol, 2-nitrophenol, aminotrityl, 2-iodylbenzamide, 4-hydroxy iodobenzene diacetate, 3-benzyloxybenzaldehyde, methylsulanylmethl, 4-carboxybenzene sulfonamide, dibutylphenylphosphine, p-toluene sulfonic acid, 4-hydroxymethyl benzoic acid, rink amide 4-methylbenzylhydrylamine, 2-chlorotrityl hydrazine, N, N′,N″-trimethylenetriamine,

2-chlorotrityl chloride, 4-benzyloxybenzyl alcohol, triphenylphosphine oxide, 2-chlorotrityl amine, 4-hydroxymethylbenzoic acid-4-methylbenzydrylamine, 4-methylbenzydrylamine hydrochloride, anthranilic acid, 4-nitrophenyl carbonate. For additional functionalized polymers see R. B. Maseto, PhD Thesis, U. South Africa, February 2010, “Aromatic Oxazolyl and Carboxyl Functionalized Polymers by Atom Transfer Radical Polymerization”, also Azlactone-Functionalized Polymers, Buck et al, Polym. Chem., 2012, 3, 66-80.

Aromatic polymers may react in solution or in suspension of aromatic solvents such as toluene, xylenes, chlorobenzene or other chlorinated aromatic/aliphatic solvents, with transition metal halides, mainly TiCl4 and/or ZrCl4, at elevated temperatures to form orthometallated moieties. Examples of aromatic polymers include, but not limited to: polyamides, polybenzoxazole, polybenzimidazole, polycarbonate, polyketone, polyetherketone, polyethersulfone, polyphenylenesulfide, polyamide-imide, polyimide, polyarylate, polyetherimide, poly (p-phenylene benzobisthiazole), polysiloxane, polyimide-siloxane. These polymers are well known in commerce under several trade names such as Kevlar,

Terlon, Kapton, Matrimid, PBT, PBI, PBO, etc. The amount of metal on the polymer after the reaction with metal chloride should be between about 0.1% to about 3%, preferably between 0.5% and 2%, and more preferably about 1%. When the reaction between the polymer and the metal chloride is in solution, control morphology particles may be prepared by using an emulsion technique, for example as outlined in U.S. Pat. No. 5,955,396.

As in the case of the metallated polymer-bound ligands, the metallated aromatic polymers may be used as catalysts in olefin polymerizations, thus forming aromatic polymer-polyolefin block copolymers. The production of aromatic polymer-polyolefin copolymers, with the methodology of the present disclosure, will have new properties for attractive applications, reducing the cost of several Engineering Thermoplastics.

Reactions with Aluminum Alkyls and Aprotic Electron Donors

Complex (IV) reacts with an aluminum alkyl (triethyl aluminum-TEA, tri-isobutyl aluminum-TIBA, etc) in toluene to form complex VI. The Titanium is alkylated and reduced from Ti (IV) to Ti(III), and a new Ti—Al bimetallic complex is formed by chloride bridging, with the aluminum chloroalkyl of the type AlRzCl_{3-z} (z=number between 0 and 3), formed during the reaction:

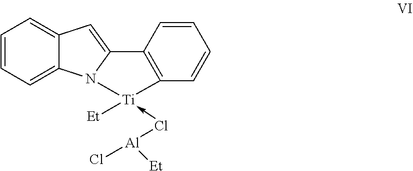

Elemental analysis and spectroscopic evidence are in support of structure (VI). An olefin coordinates with complex (VI), initiating the polymerization process. Most importantly, this geometry around the active metal, is perhaps the reason for (VI) being activated with aluminum alkyls, instead of the non-coordinating anions, MAO, perfluoroborates and the like.

Complex (IV) is the catalytic species responsible for the improved performance of DNBP/2-phenyl-indole magnesium chloride Ti chloride catalysts of this disclosure. Equivalent improved performance was registered in magnesium chloride Ti chloride catalysts with mixed internal modifiers of DNBP and one of the following ligands: 2,3-diphenyl indole, 2,3-diphenyl indenone, tetraphenyl-cyclopentadienone, 2,5-diphenyl furan, diphenyl isobenzofuran, 2,5-Diphenyl oxazole, 2,5-diphenyl-1,3,4-oxadiazole, and 2-(4-biphenyl)-5-phenyl-1,3,4-oxadiazole.

Several aprotic (not containing active hydrogen) donors may react with (IV) to yield coordination compounds, active in alpha-olefin polymerizations. Aprotic donors are chosen to prevent cleavage of the metal-aryl bond. The list of donors includes, but is not limited, to ethers, esters, ketones, tertiary amines and their oxides, carbonates and thiocarbonates, organic sulfoxides, phoshines and phoshine oxides, silanes and the like. The heteroatom of these donors coordinates with the Ti of (IV), replacing the chlorine bridge originating from the aluminum chloroalkyl.

Examples of ethers R₁OR₂ are those with R₁ and R₂ aliphatic or aromatic hydrocarbyls, the same or different, containing from 1 to about 20 carbon atoms. Preferred are di-isopropyl, di-n-butyl or di-iso butyl ether and di-isoamyl ether. Cyclic ethers such as tetrahydrofuran may also be used. Thioethers and sulfoxides are also suitable for this application, for example diphenyl sulfide and diphenyl sulfoxide.

Examples of ketons R₁COR₂ are those with R₁ and R₂ defined as above. Preferred are dipropyl-, dibutyl-, dipentyl-, dihexyl ketones, and benzophenone.

Alphatic or aromatic mono- or di-esters are particularly useful as electron donors for (II). Examples are ethyl acetate, ethyl benzoate, malonate and succinate diesters, di-n-butyl of di-isobutyl phthalate, di-octyl-phthalate etc. Esters of di-hydroxy compounds described above are particularly useful.

Another class of attractive donors are aliphatic and/or aromatic carbonates R₁OCOR₂, where R₁ and R₂, the same or different, are as defined above. Examples are dimethyl carbonate and diphenyl carbonates. Thiocarbonates of similar structures are also preferred donors for (II).

Examples of tertiary amines NR₁R₂R₃ with R₁, R₂, R₃ aliphatic or aromatic hydrocabyls, the same or different, containing from 1 to about 20 carbon atoms. Preferred are tri-n-butyl and tri-iso butyl amine, triphenyl amine, diphenyl benzyl amine. Aromatic amines such as pyridine, and particularly the 2,6-dimethyl- or 2,4,6-trimethyl-pyridine may also be employed. Among the N-oxides of tertiary amines, various isomers of picoline-N-oxide, lutidine-N-oxide, and collidine-N-oxide are preferred.

Phosphines and phosphine oxides are common donors for this application. Preferred are tributyl phospine, triphenylphospine, and the corresponding oxides. Every known silanes, especially the monoalkoxy alkyl types are preferred. Most preferred is tributyl methoxy silane.

Mixtures of the aforementioned donors may also be used. Furthermore, it is possible to treat complex (IV) with one or more donors first, followed by the aluminum alkyl treatment, by reversing the above outlined sequence, which is treatment with aluminum alkyl, followed by treatment with a donor. A third alternative is to carry-out the alkyl aluminum and donor treatment simultaneously. The preferred method is treatment with the aluminum alkyl first, followed by the reaction with the donor compound. The reason for this preference is the initial removal of HCl present in the structure of (IV) with triethylaluminum, to yield chloroethylaluminum and ethane, thus avoiding interaction of the donor with HCl. An excess of five or more moles of aluminum alkyl per mole of complex (IV) is required for this treatment.

There are countless combinations of orthometallated complexes undergoing the trialkyl aluminum with various donors treatment, outlined above. This fact illustrates the versatility and the availability of numerous new catalyst combinations of the present disclosure for the polymerization of alpha-olefins. These catalysts may be supported on silica, silica-alumina, MgCl₂, and other supports, and activated with aluminum alkyls, MAO, or other non-coordinating anions and used in every known polymerization process.

Insertion of Olefins and other Molecules into Metal-Aryl Bond, Multi-Site Catalysts

Reference was made in the Background Section to the insertion reaction of olefins into the metal-aryl

bond and the creation of multi-site catalysts. When ethylene reacts with complex (IV) the two isomers being formed by insertion, are shown in Scheme B. With propylene or higher alpha-olefins, we have the formation of eight isomers, four with an 1,2-insertion as shown in Scheme C, and four with a 2,1-insertion. Each isomer represents a unique site of polymerization, affecting the physical properties of the polymer produced.

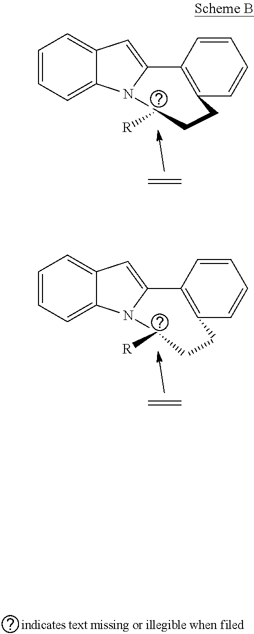

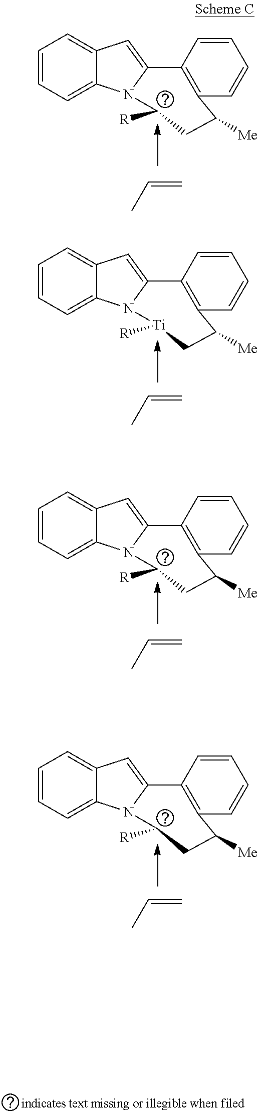

Small molecules such as O₂, CO, CO₂, CS₂, COS, and even molecular N₂ are capable of inserting into the Ti-aryl bond (nitrogen fixation), M. E. Vol'pin et al, Chem. Commun. 1038 (1968). Compounds with functional groups such as imines, carbonitriles, aldehydes, ketones, esters, amides, isonitriles, isocyanates, cyanates, thiosyanates, and isothiacyanates. Alkynes insert also into Ti-carbon bond, Tertahedron Letters 33, 1992, p. 6565.

The insertion reactions provide a platform for the discovery of new and advanced catalysts.

Reaction of Ligands with Other Transition Metal Reagents

ZrCl₄ reacts with 2-phenyl indole under the same conditions employed in the analogous reaction with TiCl4. The isolated product had identical structure to (IV), on the basis of analytical and spectroscopic evidence. The ZrCl₄/2-phenyl indole complex undergoes similar transformations with aluminum alkyls.

The transition metal reagents already mentioned, along with the various examples of ligands in this disclosure, are capable of forming adducts resembling structure (IV), including an orthometallation step. As such, they represent a new class of novel organometallic compounds, highly active in alpha-olefin polymerizations and coplymerizations, when activated with aluminum alkyls such as TEA, TIBA or other chloroalkyls such as diethyl aluminum chloride (DEAC). Furthermore, their applications may extend to other fields, such as health and electronics.

There are numerous advantages of the complexes of this disclosure, over metallocene catalysts and other coordination compounds in alpha-olefin polymerizations:

a) The ease of their preparation. The synthesis of complexes of the present disclosure is carried out as a “one pot”, single-step procedure, using readily available starting materials. It is therefore fast and economical, which makes these catalysts attractive for commercialization.

b) The preferred activators of these catalysts are aluminum alkyl activators (TEA, TIBA, etc). Non-coordinating anions, MAO, perfluoroborates and the like may also be used.

c) The complexes are stable at elevated temperatures (110° C. or above), since they are synthesized at those temperatures.

d) They are versatile in their applications as catalysts in alpha-olefin polymerizations. They act as “modifiers” of magnesium chloride supported titanium chloride catalysts. They are suitable for stereospecific polymerization and copolymerization of propylene. Supported on silica or other suitable supports, they can be used for the production of polyethylene and its copolymers. They are expected to incorporate higher levels of 1-butene, 1-hexene, 1-octene because they have an open structure. Furthermore, they can be used advantageously in continuous high temperature solution polymerization processes for the production of specialty polymers, adhesives, etc.

e) The insertion of an olefin into the metal-aryl bond gives rise to the formation of several stereoisomers, resulting in the multi-site behavior of the complexes. This behavior has a profound impact on polymer product properties, especially on MW and MW distribution. From propylene polymerization tests with magnesium chloride supported titanium chloride catalysts incorporating the complexes, we may conclude that the effect is not limited to MW. Activity is markedly increased, the stereoregularirty is higher, other physical properties such as flex modulus, impact properties etc show improvements. The insertion of small molecules and compounds with certain functional groups into the metal-aryl bond, as illustrated earlier, offers additional flexibility for improvements into the catalytic system.

f) Mixtures of complexes from the present disclosure with metallocenes of various ligand structures or same/different metal centers, as well as other coordination or organometallic compounds may be employed as catalysts, for producing polymers with targeted properties such as ultra high MW, or to achieve additional product and process improvements. These mixtures may be supported on silica, silica-alumina or other supports well known to those skilled in the art. The mixtures may also be used in high temperature solution processes.

g) Mixtures of orthometallated catalysts with two or more different ligands of this disclosure, or two or more transition metal types may be applied in alpha-olefin polymerization.

h) Spray-drying, U.S. Pat. No. 5,672,669, or emulsion techniques, U.S. Pat. No. 8,420,562, may be applied to prepare controlled morphology catalysts with the orthometallated complexes of this disclosure.

o) The orthometallated complexes of present disclosure may be used in every known industrial polymerization process, gas-phase, bulk, slurry, and/or solution. If so desired, a solution of the complexes in a hydrocarbon solvent may be sprayed through a nozel in the polymerization reactor. Alternatively, the solution may be combined with the aluminum alkyl (TEA, TIBA, etc.) stream in the process.

p) In certain industrial processes such as the stereospecific polymerization of propylene with magnesium chloride supported titanium chloride catalysts, several dimethoxydialkyl silanes are used as external modifiers, to control the stereoregularity of the polymer. The presence of the orthometallated complexes under polymerization conditions may reduce the need for silanes up to 70%, and in certain cases up to 100%. By reducing the level of silanes, an additional polymerization activity in the order of about 15-20% is observed.

### EXAMPLES

### Example 1

Preparation and Structural Characterization of the TiCl₄/2-Phenyl Indole Complex (IV)

Under a dry N₂ atmosphere inside a drybox, with magnetic agitation, a solution of TiCl₄ in toluene was added to a solution of 2-phenyl indole in toluene, at a molar ratio of ½, at ambient temperature. The temperature was raised to about 105° C. and an oily dark orange product was formed. Heating was turned off, the supernatant decanted, and the remaining was washed four times with toluene. During

this process the product crystallized. It was further washed five times with hexane, and dried in vacuo. Analytical and spectroscopic evidence indicates that the product is about 97% pure, the remaining being residual hexane.

The characterization of the structure of (IV) was based on elemental analysis, solid-state ¹³C NMR, on IR spectra, and on computational chemistry calculations with structural modeling.

Cross-polarization with magic angle spinning (CPMAS) solid state ¹³C NMR technique was used. The samples were packed into MAS rotors in dry box, and dry N₂ was used for sample spinning to prevent sample exposure to moisture. Typical CPMAS experimental conditions used were: external magnet=2.35 tesla; CP contact time=2 milliseconds; proton spin-lock radio-frequency field=40 Khz; recycle delay=3 seconds. Dipolar dephasing (DDMAS) technique, with 40 microseconds dephasing time was used to obtain quarternary (and methyl) carbons only spectra, to aid in spectral assignment.

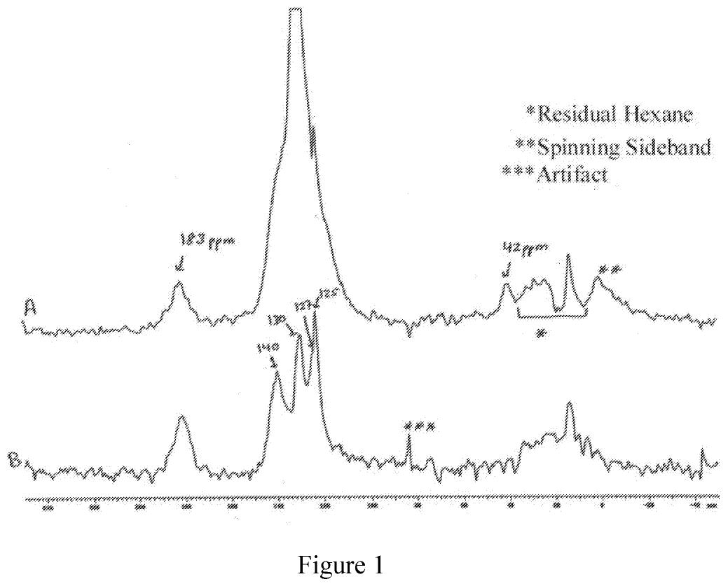

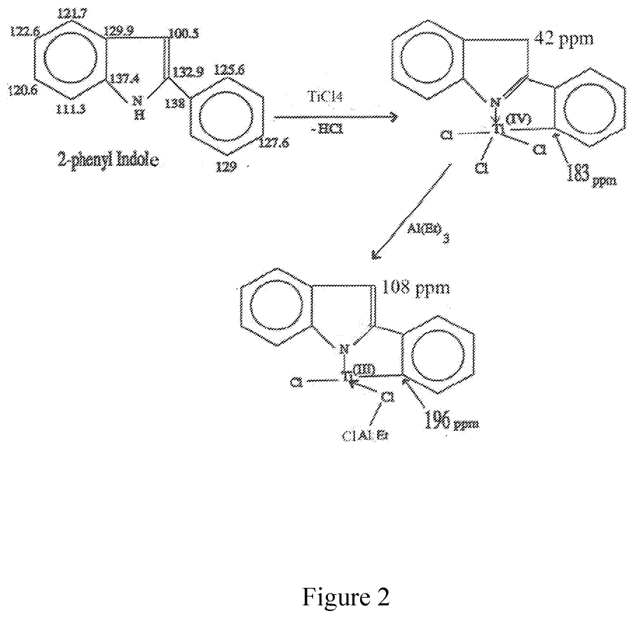

Both types of ¹³C NMR spectra for (IV) are shown in FIG. 1. The ¹³C NMR assignments for each carbon of pure phenyl-indole are presented in FIG. 2. The spectra in FIG. 1 have a small peak at 183 ppm that cannot be assigned to any carbon in pure 2-phenyl indole. The DDMAS spectrum further indicates that this peak is due to a quaternary carbon. There are four more quaternary carbons in (I) which roughly correspond to four quaternary aromatic carbon peaks seen in the spectrum (FIG. 1), though their exact assignment can not be ascertained. Furthermore, an aliphatic carbon peak at ca. 42 ppm due to a nonquaternary carbon, can be assigned to the lone CH2 carbon.

The 183 ppm peak is assigned to the quaternary carbon directly bonded to Ti through orthometalation, and formation of a five-member metalocycloimine ring.

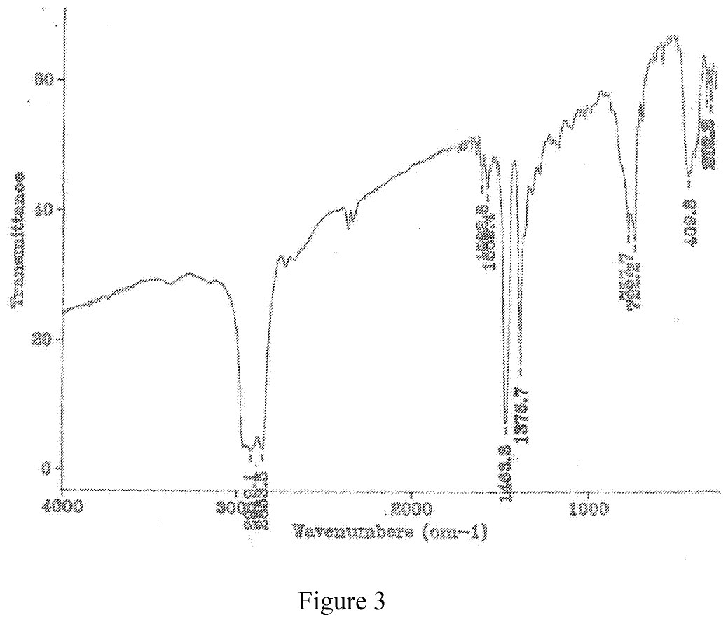

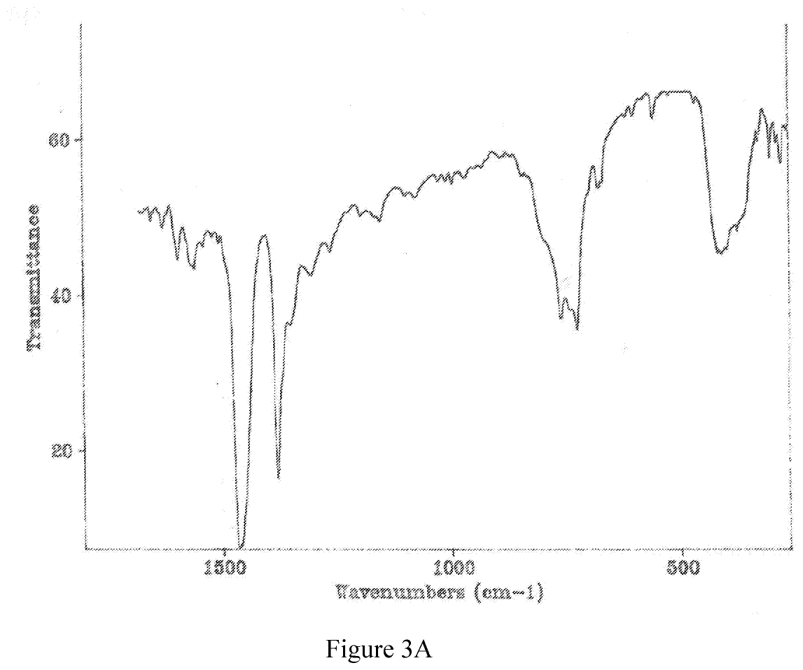

The IR spectrum of (IV) is presented in FIG. 3 and FIG. 3A. Four very strong absortions at 418, 410, 398, 375 cm-1 are assigned to v Ti—Cl. By comparison, TiCl₄.DNBP which has an octahedral configuration around Ti, showed maxima at 406, 400, 383, 374 cm-1, Gregory G. Arzoumanidis et al Catalytic Olefin Polymerization, Proceedings of Interanional Symposium, Tokyo, Oct. 23-25, 1989 (Kodanska, Ltd.). A strong band of 2-phenyl-indole at 685 cm-1 characteristic of five consecutive H atoms in a phenyl group, is not present in (IV). Instead, a new band appears at 722 cm-1 assigned to four consecutive H atoms in an aromatic ring, a supporting evidence for the orthometalation of the phenyl group.

The HCl produced by the orthometalation of the phenyl group is being retained in the structure (IV). There is creation of an Cl . . . H—Cl species, which has been demonstrated in several other crystal structures, Brian H. Ward et al, Chem. Mater., 1998, 10 (4), pp. 1102-1108, or Ph₄AsCl.HCl, which is an item of commerce.

The oxidation state of Ti in (IV) was confirmed to be +4 using X-ray photoelectron spectroscopy (XPS). The binding energy (BE) of Ti 2p3/2 photoelectrons in the complex was found to be 458 eV from the XPS data. This value of BE compared to literature data of other Ti compounds suggests +4 oxidation state for Ti.

### Example 2

Reaction of Complex (IV) with Triethylaluminum, Formation of Complex (VI)

Complex (IV) was suspended in toluene and reacted with excess triethyl aluminum in the dry box at ambient temperature. The product of the reaction was washed several times with toluene, and then with hexane, dried under vacuo.

During the treatment of (IV) with the aluminum alkyl, the HCl is neutralized through the formation an aluminum chloroalkyl and ethane:

AlEt₃+nHCl=AlEt₃₋ₙClₙ₊ₙEtH

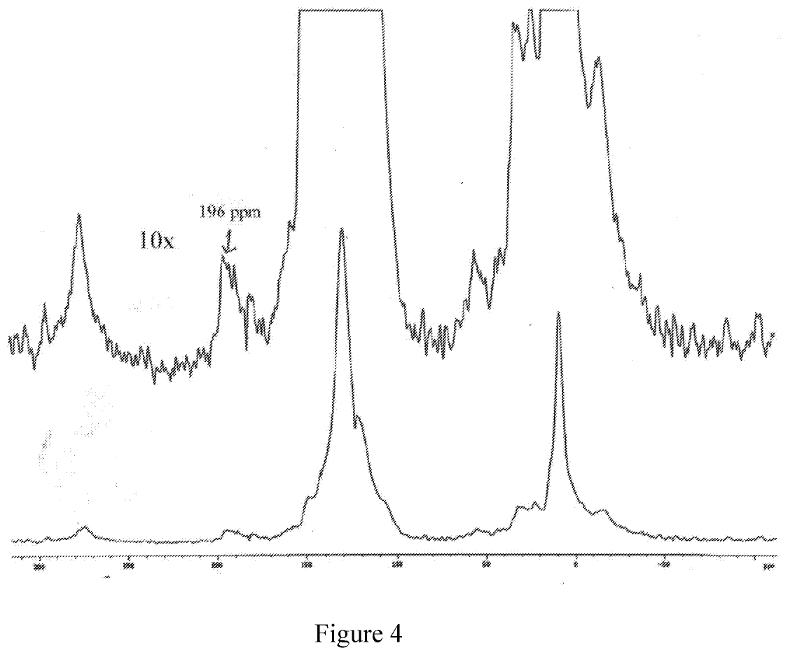

The alkyl aluminum reduces the Ti(IV) to Ti(III) and abstracts an additional HCl from the organometallic moiety as well, by rearranging the double bond in the indole structure back in its original 2,3-position, and formation of a N—Ti sigma bond. This is illustrated in the ¹³C CPMAS spectra FIG. 4. There is a new shoulder peak at 108 ppm, which we assign to the new quaternary carbon in the 3 position. The CH₂ carbon previously representing the 3 position in (IV) is not there any more. The peak assigned to phenyl carbon bonded to Ti is shifted further downfield to 196 ppm. The spectrum shows a large peak at ca. 15 ppm from ethyl carbons, indicating alkylation on the Ti, and possible aluminum alkyl incorporated in the structure. The analytical results are consistent with a coordinated chloroalkyl aluminum with the formula AlEt_{0.3}Cl_{2.7} i.e., roughly a mixture of 90% AlCl3 and 10% AlEtCl₂. The ratio of the AlCl₃ and AlEtCl₂ may vary, depending on reaction conditions, reactant ratios, etc. Accordingly, the bimetallic is essentially an AlCl₃ adduct of an alkylated Ti(III)-orthometalated phenyl indole.

### Example 3

Reaction of Complex (VI) with Donor Molecules

DNBP reacts with (VI) in toluene or other aromatic or aliphatic solvent, under mild conditions at a molar ratio of 2:1, to yield a product wherein the diester replaces AlCl₃ in the complex through coordination of the two carbonyl groups with Ti.

Numerous other donor molecules recorded in this disclosure are capable of yielding similar adducts, following the same procedure.

### Example 4

Reaction of 2-Phenyl Indole with ZrCl₄

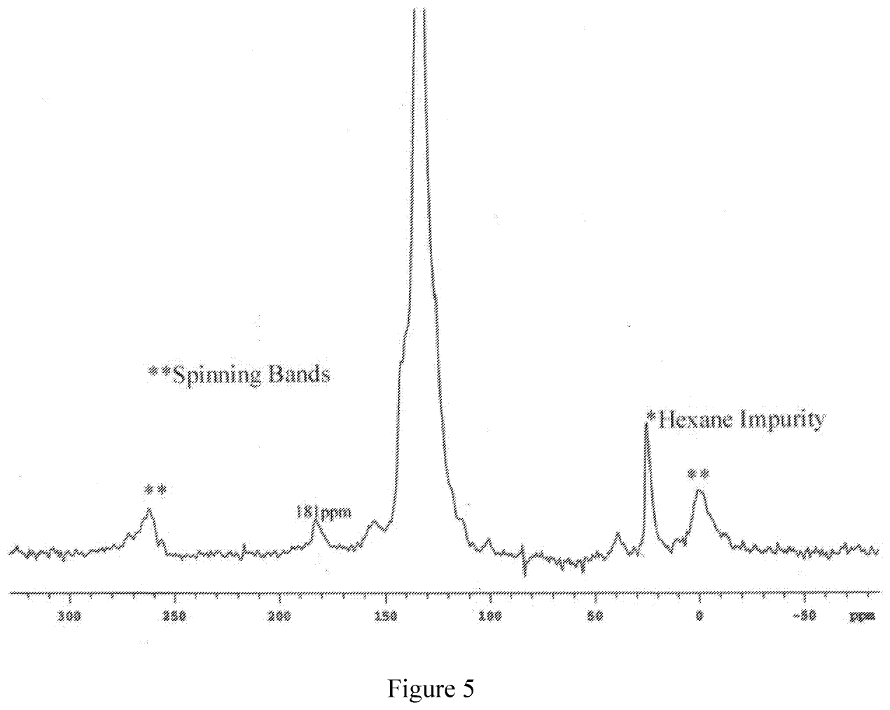

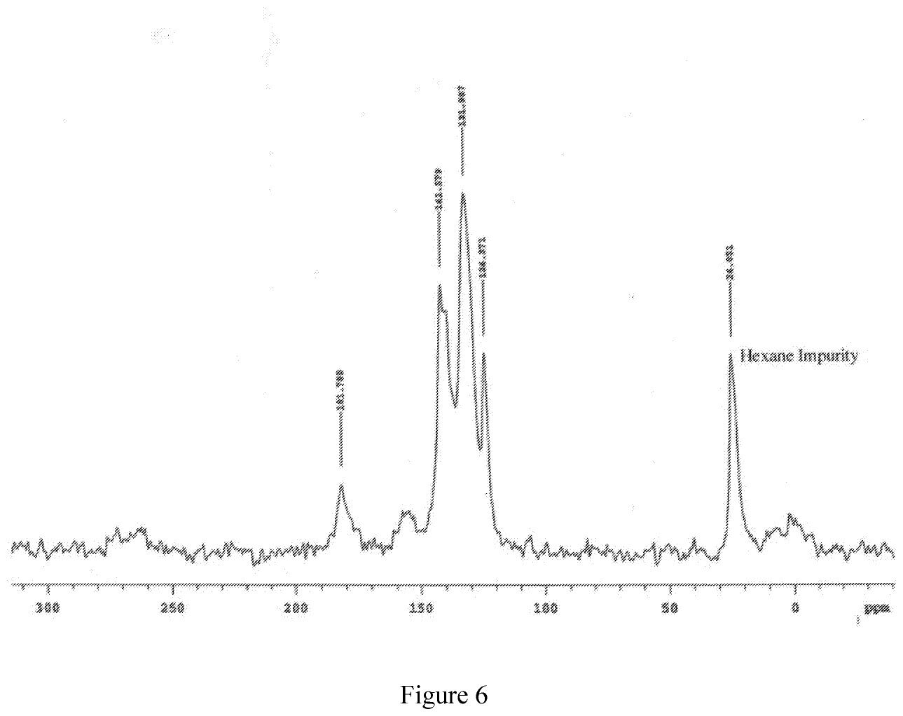

The procedure outlined in Example 1 was repeated, except ZrCl₄ was used instead of TiCl₄. The isolated product had some residual hexane as impurity, despite being treated in vacuo. The DDMAS and CPMAS solid state 13C NMR spectra of the isolated product (FIG. 5 and FIG. 6) closely resemble those of the TiCl₄ complex (IV). The Zr-aryl bond in ¹³C NMR is at 181 ppm. This implies that the ZrCl₄ complex is structurally similar to (IV). Analytical data support this interpretation.

### Examples 5 through 8

MgCl₂ Supported Catalyst Preparations with Mixed Donors

Magnesium chloride supported titanium chloride catalysts were prepared following the procedure by Arzoumanidis et al in U.S. Pat. No. 5,124,297, Example 1. In these preparations mixtures of DNBP/2-phenyl indole at molar ratios of 50/50, 75/25, 85/15 and 80/90 was used.

The catalyst were tested in a slurry propylene polymerization test, in batch gas phase and in a continuous laboratory gas phase unit.

The batch hexane slurry polymerization evaluated the performance of propylene polymerization catalyst relative to a control catalyst. The polymerization takes place in a two liter reactor using 1 liter of hexane, 10 mg of catalyst, triethylaluminum, diisobutyldimethoxysilane, and enough H₂ to achieve a melt flow rate of ca. 5 g/10 min. The hexane, catalyst system, H₂, and propylene were added to a cool reactor, and the reactor heated to 160° F. over a 10 min period. The reactor pressure was maintained at 150 psig by feeding propylene on demand. The polymerization was run for 1 hour starting from the time the temperature reached 150° F. At the end of the polymerization, the pressure was vented, the polymer slurry filtered, the polymer dried in a vacuum oven and weighed, and a 100 ml aliquot of the hexane filtrate evaporated to determine percentage soluble portion.

The batch gas phase polymerization test is described in U.S. Pat. No. 5,124,297.

The 50/50 and 75/25 catalysts showed activity lower than the control, which is a catalyst prepared with only DNBP as the internal modifier. Also, the powder bulk density of the 50/50 and 75/25 was substantially lower than the control.

The 85/15 and 90/10 catalysts gave a 40-65% activity improvement over the control, lower extractables and overall better powder bulk density, by about 10%.

### Examples 9-15

MgCl₂ Supported Catalyst Preparations with DNBP Mixed with Various Donors at 85/15 Molar Ratio

The procedure of the previous Example was followed to prepare MgCl₂ supported catalysts using mixtures of DNBP with seven different donors, at the optimum molar ratio of 85/15 respectively. All the catalysts prepared showed improved performance over the control, as indicated on Table 1.

TABLE 1
Percent Polymerization Yield Advantage with Several
Ligands/Intemal Modifiers mixed with DNBP (DNBP/Donor =
85/15 molar) of MgCl₂ Supported Catalysts

| | | Polymerization Test | | |
|---|---|---|---|---|
| | | | Batch Gas | Continuous Gas |
| No | Donor | Slurry | Phase | Phase |
| 1 | 2-Phenyl | 36% | 48% | 65% |
| | Indole | | | |
| 2 | 2,5-Diphenyl | 21 | 35 | |
| | Furan | | | |
| 3 | Diphenyl | 27 | | |
| | Isobenzofuran | | | |
| 4 | 2,5-Diphenyl | 46 | | |
| | Oxazole | | | |
| 5 | 2,3-Diphenyl | | 40 | 65 |
| | Indole | | | |
| 6 | 2,3-Diphenyl | | 54 | |
| | Indenone | | | |
| 7 | Tetraphenyl | | 61 | |
| | Cyclopentadienone | | | |

The batch gas phase procedure has been described in the aforementioned patent, Example 1. The continuous gas phase system is similar to the batch, but it is automated for continuous operation.

It is further understood that various other modifications to these examples may be made to those skilled in the art, within the spirit and scope of this disclosure.

### Comparable Example 1

MgCl₂ Supported Catalyst Preparation with 2-Phenyl Indole as the Internal Modifier

A MgCl₂ supported catalyst was prepared following the procedure of the earlier Examples, using 2-phenyl indole as the only internal modifier. The activity of the catalyst in batch gas phase polymerization was only 30% of the activity of the control.

What we claim is:

1. A method to produce an alpha-olefin polymerization catalyst comprising the steps of:
reacting:
(a) a compound characterized by the formula:
Ar_{X}-L-E
wherein Ar is phenyl, naphthyl, biphenyl, anthracenyl, phenanthrenyl or their isomers. For example, “naphthyl” can be 1- or 2-naphthyl, “biphenyl” can be 1-, 2-, or 3-biphenyl, “anthracenyl” can be 2-, or 9-anthracenyl, “phenanthrenyl” can be 1-, 2-, 3-, or 9-phenanthrenyl. Ar is bonded to L;
wherein x is an integer from 1 to 15, more preferred 1-5
wherein L is one of the following:
i. a heterocyclic ligand, wherein heterocyclic refers to aromatic or aliphatic, 3 to 7, or higher member rings containing one or more heteroatoms, wherein heteroaromatic rings may include pyridine, pyrimidine, pyrazine, pyrrole, furan, imidazole, pyrazole, triazole, thiazole, isothiazole, oxazole, isoxazole, oxadiazole, phospholene, phospholene oxide, phosphorine (analogue of pyridine containing P), and benzo-fused analogues of these rings such as indole, carbazole, benzofuran, benzothiophene, purine, 2H-chromene, xanthene, and the like, and heteroaliphatic rings such as ethylene oxide (oxirene), ethylenimine (aziridine), trimethylene oxide (oxetane), tetrahydrofuran, purrolidine, piperidine, dioxane, morpholine, trimethylene sulfide, 1,3-diacetidine, 1,2-oxathiolane, oxepane, azocane, thiocane, and the like;
ii. Unsaturated cyclic ketones which may include cyclopentadienone, cycloheptatrienone, their sulfur and imino analogues; or
iii. Functional group moieties: —COR, —NR′R″, —SR, —PR′R″, —OR, —N═N—, —N═CR—, and the like, directly bonded to Ar, as defined above. R, R′, R″, the same or different, are separately H, alkyl, or aryl. Examples are benzophenone, diphenylamine, diphenylether, triphenylphospine, triphenylphospine oxide, anisole, and the like,
wherein E is a heteroatom, included in L, available for coordination with the transition metal; and
(b) a metal halogenide, wherein a metal of the metal halogenide is selected from groups 3-6, 8, and the lanthanide series of a periodic table of elements.

2. The method of claim 1, wherein the Arₓ-L-E compound is 2-phenyl indole, 2,3-diphenyl indole, 2-biphenyl indole, 2,5-diphenyl furan, diphenyl isobenzofuran, 2,5-diphenyl oxazole, 2,3-diphenyl indenone, tetraphenyl cyclopentadienone, 5-phenyl-1,3,4-oxathiazole-2-one, plus all the formulas in Table 1.

3. The method of claim 1, wherein the metal halogenide is TiCl4, TiBr4, TiF4, ZrCl4, HfCl4, CrCl3, VCl3, SmCl3, YCl3, TaCl3, NbCl3, TaCl5, NbCl5, RuCl3, IrCl3, PtCl4, RhCl3, PdCl2, FeCl3, FeCl2, NiCl2, NiBr2, CoCl2.

4. The method of claim 1, with the reaction carried out in solution of aromatic, aliphatic or chlorinated organic solvents, n solvents, under a blanket of nitrogen or argon, toluene being the preferred solvent.

5. The method of claim 1, with the reaction carried out at temperatures between 50° C. and 160° C., preferably between 80° C. and 140° C., and more preferably between 100° C. and 120° C.

6. A product resulting from the method of claim 1, from the reaction of 2-phenyl indole with TiCl₄, the composition comprising the following new composition of matter:

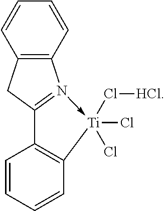

7. A product resulting from the method of claim 1, from the reaction of 2-phenyl indole with ZrCl₄, the composition comprising a new composition of matter with the same structure as in claim 6, but with Zr in place of Ti.

8. A product resulting from the method of claim 1, wherein two or more Arₓ-L-E compounds participate in the reaction, with one or more metal halogenides.

9. The product of claim 6 with aluminum alkyls AlR₃, triethylaluminum AlEt₃ (TEA), tri-isobutyl aluminum Al(i-Bu)3 (TIBA) and the like, comprising the chemical formula: 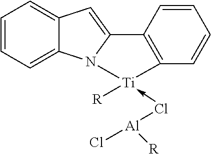
Wherein the Al moiety in this formula is represented by the formula AlRzCl_{3-z}, (z is any number between 0 and 3), R is alkyl, comprising 1 to 20 carbon atoms), and varies with the reaction conditions.

10. The product of claim 9 forming a secondary product by the reaction with an electron donor, comprising ester, ether, ketone, amine, phoshine, and the like.

11. The product of claim 9 further reacted with ethylene, comprising the two formulas shown in Scheme B.

12. The product of claim 9 further reacted with an alpha-olefin, propylene or higher, comprising the four formulas shown in Scheme C from a 1,2-insertion, and another four from a 2,1-insertion.

13. The product of claim 9 further reacted with acetylene or other alkyne.

14. The method of claim 1 wherein the ligand Arₓ-L-E is mixed with other internal modifiers of MgCl₂ supported TiCl₄ polypropylene catalysts, one of: butylphthalate esters, succinate esters, 1,3-dialkyl diethers, organic carbonates, sulfonyl compounds, organosilicon compounds, ketone-ether derivatives, aliphatic cyclic esters, 1,8-naphthyl-diaryloates, esters of dialcohols, during corresponding catalyst preparations at molar ratios modifier/Arₓ-L-E from between 95/5 to 75/25, most preferred between 90/10 to 83/17.

15. The product of claim 6, activated with aluminum alkyls under propylene polymerization conditions to form a stereoregular polymer.

16. The aluminum alkyls of claim 15 are triethylaluminum, and tri-isobutyl aluminum, optionally MAO or ammonium perfluoroborates or mixtures thereof.

17. The product of claim 9, in combination with a MgCl₂ supported TiCl₄ catalyst, and optionally delivered mixed with the aluminum alkyl activator, for the production of isotactic polypropylene and other stereoregular polypropylenes.

18. The product of claim 6, applied in polymerization of ethylene, propylene, 1-butene, 1-pentene, 1-hexene, 1-octene, and higher alpha-olefins, styrene, cyclic alkenes, dienes, functionalized alpha-olefins, and combinations thereof.

19. The method of claim 14 comprising a gas-phase, bulk, suspension, or solution.

20. The product of claim 6, wherein the product is supported on silica, silica-alumina, their fluorinated analogues, and used in olefin polymerization.

21. The product of claim 6, wherein the method further comprises the step of producing an adhesive through a high temperature solution polyolefin processes.

22. The product of claim 21, wherein the temperature of the process is between ambient and 250° C., preferably between 100° C. and 220° C., and more preferably between 140° C. and 200° C.
